(19) United States
(12) Patent Application Publication
(10) Pub. No.: US 2015/0336217 A1
(43) Pub. Date: Nov. 26, 2015

(54) BORON-FREE SOLDER WITH MANGANESE AND GERMANIUM, POWDER AND REPAIR METHOD

(71) Applicant: SIEMENS AKTIENGESELLSCHAFT, München (DE)

(72) Inventors: Michael OTT, Mülheim an der Ruhr (DE); Sebastianü PIEGERT, Lübbenau (DE)

(21) Appl. No.: 14/760,560

(22) PCT Filed: Dec. 19, 2013
(86) PCT No.: PCT/EP2013/077325

§ 371 Date: Jul. 13, 2015

(30) Foreign Application Priority Data
Jan. 11, 2013 (EP) 13150978.8

(51) Int. Cl. B23K 35/30; B23K 31/02; C22C 19/07; B23P 6/00; C22C 19/05

(52) U.S. Cl. CPC B23K 35/304; B23P 6/00; B23K 35/3046; C22C 19/057; C22C 19/056; C22C 19/055; C22C 19/07; B23K 31/02

(57) ABSTRACT

A nickel-based alloy that includes at least nickel, manganese, and either germanium or both germanium and gallium, the alloy being free of boron or silicon, a solder based on the alloy, a powder based on the alloy, and a method of repairing a component with the alloy.

### CROSS-REFERENCE TO RELATED APPLICATIONS

The present application is a 35 U.S.C. §371 national phase conversion of PCT/EP2013/077325, filed Dec. 19, 2013, which claims priority of European Patent Application No. 13150978.8, filed Jan. 11, 2013, the contents of which are incorporated by reference herein. The PCT International Application was published in the German language.

### FIELD OF THE INVENTION

The invention relates to an alloy comprising nickel, manganese and germanium which can be used, in particular, for soldering.

### BACKGROUND AND SUMMARY OF THE INVENTION

Soldering methods are also used for the repair of components. The soldering material used is often a material which is compatible with or the same as the material in the substrate to be repaired, with a melting-point reducer such as, for example, boron or silicon.

The melting-point reducers also lead to undesired precipitations. The precipitations reduce the properties of the substrate and therefore of the repaired, soldered site.

This is not desired.

It is therefore an object of the invention to provide an alloy which is free of boron or silicon and has no undesirable precipitations.

The object is achieved by an alloy as claimed, a powder as claimed and a method as claimed.

### BRIEF DESCRIPTION OF THE FIGURE

FIG. 1 shows a list of superalloys.

### DETAILED DESCRIPTION

The description and the FIGURE represent only exemplary embodiments of the invention.

According to the invention, use is made of an at least ternary system consisting of nickel-manganese-germanium (Ni—Mn—Ge), to which gallium (Ga) can be added to replace germanium (Ge) at least in part. Some alloy embodiments do not include gallium.

“Alloying element” means that the proportion lies very considerably above the impurity limit.

An advantageous value range (in at %) is as follows:

1% to 60% manganese (Mn), with use preferably being made of at most 25 at % manganese (Mn).

The minimum values for manganese (Mn) are 2 at %, 5 at % or 10 at %.

The values for germanium (Ge) are 1 at % to 15 at %. The alloy also comprises 0 at % to 23 at % gallium (Ga) and nickel (Ni), with use preferably being made of at most 10 at % germanium (Ge).

The minimum values for germanium (Ge) are preferably 2 at % or 5 at %.

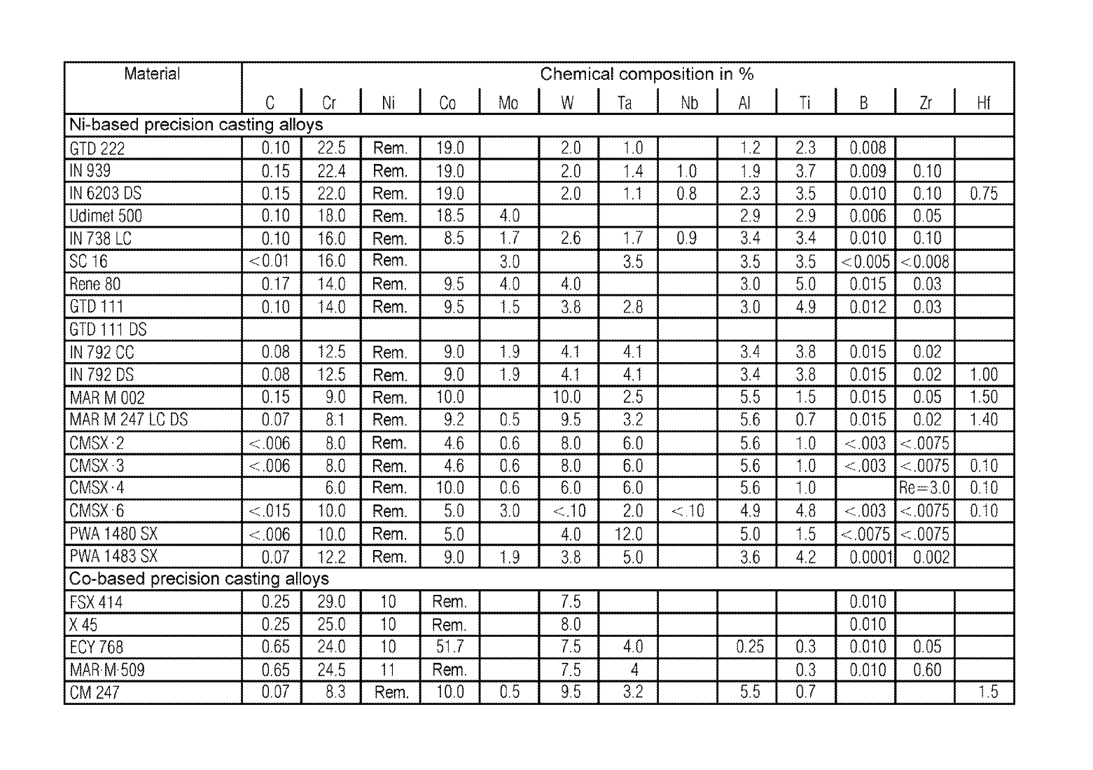

In addition, aluminum (Al) and/or chromium (Cr) and further constituents (molybdenum (Mo), titanium (Ti), tantalum (Ta), tungsten (W) , . . . ) of known cobalt-based or nickel-based superalloys as shown in FIG. 1 can be used in the alloy, but not melting-point reducers such as silicon (Si) and/or boron (B).

This alloy, or a powder comprising this alloy, can be applied to a substrate in an isothermal method and fill a recess or a crack or can be allowed to solidify by means of a temperature gradient method.

In both of the thermal methods, the crystallographic structure of the substrate can be adopted, this representing a columnar or a single-crystal structure in the case of directionally solidified nickel-based premium materials.

The alloy can be applied in the form of a powder, a slip, a solid material or a film.

The addition of germanium/manganese leads to a reduction in the melting temperature and also promotes the precipitation hardening of this alloy by germanium-based gamma precipitations.

1. A nickel-based alloy
which comprises as alloying elements
at least nickel (Ni), manganese (Mn), and germanium (Ge) or both germanium (Ge) and gallium (Ga) and includes no melting point reducers.

2. The alloy as claimed in claim 1, wherein the alloy does not include gallium (Ga).

3. The alloy as claimed in claim 1, wherein the alloy further comprises gallium (Ga).

4. The alloy as claimed in claim 1, which comprises 1 at % to 60 at % manganese (Mn).

5. The alloy as claimed in claim 1, which comprises at least 2 at % manganese (Mn).

6. The alloy as claimed in claim 1, which comprises 1 at % to 15 at % germanium (Ge).

7. The alloy as claimed in claim 1, which comprises at least 2 at % germanium (Ge).

8. The alloy as claimed in claim 1, which comprises 1 at % to 23 at % gallium (Ga).

9. (canceled)

10. The alloy as claimed in claim 1, which comprises no boron (B) and/or no silicon (Si).

11. The alloy as claimed in claim 1, which further comprises at least one element selected from the group consisting of molybdenum (Mo), titanium (Ti), tantalum (Ta), and tungsten (W).

12.-14. (canceled)

15. A powder which comprises an alloy as claimed in claim 1.

16. A method for repairing a component, comprising repairing the component with an alloy as claimed in claim 1.

17. The method as claimed in claim 16, in which an isothermal soldering method is carried out.

18. The method as claimed in claim 17, in which a temperature gradient method is employed during the soldering.

19. The alloy as claimed in claim 1, further comprising an alloying element in the amount of at least 1 at % selected from a group consisting of aluminum (AL) and chromium (Cr).

20. The alloy as claimed in claim 4, which comprises 1 at % to 25 at % manganese (Mn).

21. The alloy as claimed in claim 1, which comprises at least 5 at % manganese (Mn).

22. The alloy as claimed in claim 1, which comprises at least 10 at % manganese (Mn).

23. The alloy as claimed in claim 1, which comprises 1 at % to 10 at % germanium (Ge).

24. The alloy as claimed in claim 1, which comprises at least 5 at % germanium (Ge).

25. The method as claimed in claim 16, wherein the alloy is in powder form.

26. The method as claimed in claim 16, wherein the component is made of a cobalt based superalloy or nickel-based superalloy.

27. The alloy as claimed in claim 1, further comprising alloying elements of cobalt-based super alloys or nickel-based super alloys.
